(19) United States
(12) Patent Application Publication
(10) Pub. No.: US 2005/0193407 A1
(43) Pub. Date: Sep. 1, 2005

(54) Disc storage case

(76) Inventor: Andre Lessard, Laval (CA)

Correspondence Address: INVENTARIUM, Suite 1607, 4050 Rosemont blvd, Montreal, QC, H1X 1M4, CA

(21) Appl. No.: 11/069,467

(22) Filed: Mar. 1, 2005

Related U.S. Application Data
(60) Provisional application No. 60/548,248, filed on Mar. 1, 2004.

(51) Int. Cl. G11B 23/03; B65D 85/30; B65D 85/57

(52) U.S. Cl. 720/728; 206/308.1

(57) ABSTRACT

The present invention relates to a case or box for storage of compact discs, card discs, DVDs or the like (collectively referred to as “discs”) and methods, and is more particularly concerned with a closing mechanism and includes a stacking, storing or filing means. To attain these ends, the present invention generally comprises a case for storing at least one disc having two covers separaable from one another, at least one cover comprises a recess and a central engaging means for removably receiving a disc, and an attachment means for magnetically attaching said two covers to one another. In a second aspect of the present invention, there is provided a case for storing two discs, said case comprising two covers separatable from one another, each cover comprising a recess and a central engaging means for removably receiving one of the discs, and an attachment means for magnetically attaching said two covers to one another. Alternatively, the attachment means includes two magnets mounted on each cover and positioned in a side-by-side relationship and with a reverse polarity relative to one another.

This application claims priority based on provisioanl application 60/548,248 filed Mar. 1, 2004.

### BACKGROUND OF THE INVENTION

1. Field of the Invention

The present invention relates to a case or box for storage of compact discs, card discs, DVDs or the like (collectively referred to as “discs”) and methods, and is more particularly concerned with a closing mechanism and includes a stacking, storing or filing means.

2. Background of the Invention

It is well known in the art to use a casing for storing DVDs, CDs or various discs. Standard plastic cases have two panels connected by a hinge-like means that is generally easily broken apart, whilst a central engaging means is present to hold the disc in place. The cases can be laid one on top of the other without any retaining means there between. They cannot therefore be moved easily, without slipping, while they are stacked. A large variety of racks has been developed to hold or file a number of disc cases. Most rack supports combine their filing means with aesthetics purposes while others offer a carrying or transporting function. All of these racks or mini-luggage use more volume than a simple method of stacking the disc cases together. Other well-known multiple disc holders can carry a relatively large number of discs in a small compact container, but this transportation means is without the original casings provided with the discs; casings which sometimes hold pertinent information for the user.

Accordingly, there is a need for an improved case for disc with a simple configuration.

### SUMMARY OF THE INVENTION

In view of the foregoing disadvantages inherent in the known devices now present in the prior art, the present invention, which will be described subsequently in greater detail, is to provide objects and advantages which are:

To have a case for storing at least one disc can close magnetically.

Another advantage of the present invention is that the case for storing at least one disc can be magnetically stacked or filed over another case, thereby using minimum storage space and enabling an easy handling or transfer of a series of cases. A further advantage of the present invention is that the case can store two discs.

Still another advantage of the present invention is that the case for storing at least one disc is hingeless and does not have fragile small pieces being used as hinges.

Another advantage of the present invention is that the case for storing at least one disc is adaptable to various types of disc.

Still a further advantage of the present invention is that the case for storing at least one disc can be easily handled and is simple and non-expensive to manufacture.

To attain these ends, the present invention generally comprises a case for storing at least one disc having two covers separaable from one another, at least one cover comprises a recess and a central engaging means for removably receiving a disc, and an attachment means for magnetically attaching said two covers to one another.

In a second aspect of the present invention, there is provided a case for storing two discs, said case comprising two covers separatable from one another, each cover comprising a recess and a central engaging means for removably receiving one of the discs, and an attachment means for magnetically attaching said two covers to one another.

Alternatively, the attachment means includes two magnets mounted on each cover and positioned in a side-by-side relationship and with a reverse polarity relative to one another.

Typically, the attachment means includes supra magnets or the like.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE PREFERRED EMBODIMENT

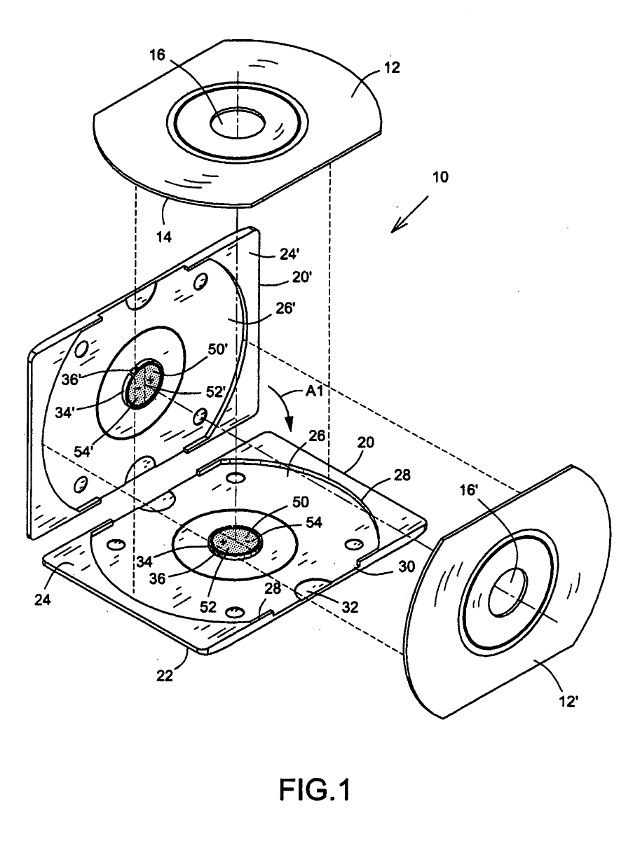

FIG. 1 Perspective view of an embodiment of an open case for storing two discs in accordance with the present invention.

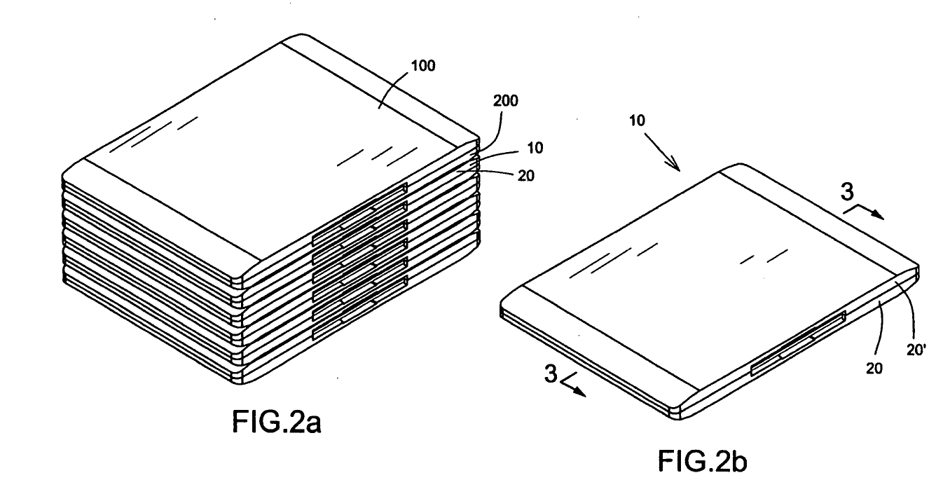

FIG. 2a Perspective view of a series of closed embodiments of FIG. 1 stacked one over the other.

FIG. 2b Perspective view of a closed embodiment of FIG. 1.

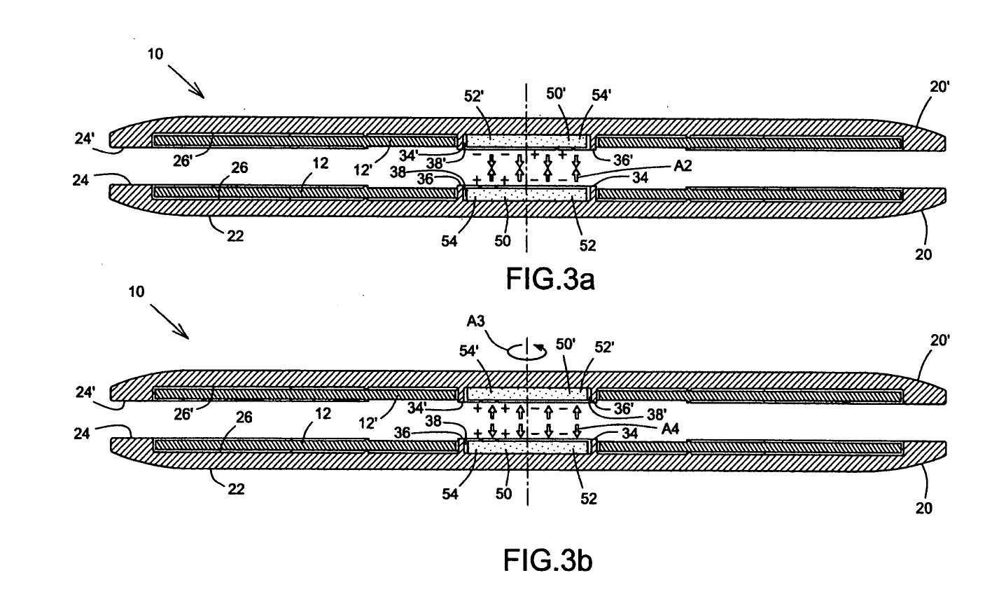

FIG. 3a Section view taken along line 3-3 of FIG. 2b showing the embodiment being closed, just before the closed position; and

FIG. 3b Section view taken along line 3-3 of FIG. 2b showing the embodiment being opened, just after initiating a rotation, up to 90° and beyond, of one cover relative to the other one from the closed position.

### DETAILED DESCRIPTION OF THE PREFERRED EMBODIMENT

A disc storage case 10 is in an open configuration and comprises a first and a second cover, 20 and 20′ respectively, that are separatable from one another.

Also shown are two discs, 12 and 12′ removed from the covers 20 and 20″ respectively.

The cover 20 has a generally rectangular and flat configuration, is slightly larger than the disc 12 it intends to protect and store, and is manufactured with a rigid, light and inexpensive material. As shown in the figures, the disc storage case (10) is for card discs but a slightly larger, somewhat squarer case could accomodate round discs such as CDs or DVDs. The cover 20 defines an exterior surface 22 and an interior surface 24. The interior surface 24 comprises a recess 26. The depth of the recess 26 is generally as of the thickness of the disc 12, while its outer edges 28 are configured and sized to follow the outer perimeter 14 of said disc 12. At least one indentation 30 appears preferably on the edge 28 of the recess 26 with a further recess 32 to allow for a finger of a user to more easily grasp the disc 12 for removal therefrom. From the generally central portion of the recess 26 emerges an engaging means 34 for the disc 12. The generally circular engaging means 34 comprises flexible projecting stems 36 corresponding to the thickness of the disc 12 and are preferably circularly positioned to engage edges defining a central hole 16 (or opening) of the disc 12. If necessary, the stems 36 can further comprise cogs (not shown) or transversal projections at their upper section, said cogs pointing toward the outer edges 28 of the recess 26 in order to hold the disc more resiliently, as found in most conventional disc cases.

On the interior surface 24 of the cover 20, preferably centrally located in between the stems 36 of the engaging means 34, is an attachment means 50 for the case 10. Typically, the attachment means 50 comprises a magnet divided into two generally semi-circular sections 52 and 54 with different molecular orientations, also shown in FIGS. 3a and 3b. Each magnet section 52, 54 has a preferably axial magnetic field and may be of the Neodymium Iron Boron (NdFeB) composition, conventionally known as or called a supra magnet, or the like. The magnet sections 52 and 54 of the cover 20 are preferably oriented with reversed polarities relative to one another in order to have their magnetic field in the opposite direction. Obviously, one skilled in the art would understand that the two magnet sections 52, 54 could be two physically separate magnets without departing from the scope of the present invention.

In order to keep the stems 26 generally flexible for the removable attachment of a disc 12, the magnet of the attachment means 50 is typically spaced apart therefrom by leaving a gap 38 there between and substantially all around.

The cover 20′ comprises a similar attachment means 50′ for the case 10, including two magnet sectionss 52′ and 54′, to that of cover 20. The cover 20″ also comprises, preferably, a recess 26′ and an engaging means 34′ for a disc 12′ as well as the other appropriate elements of the interior surface 24′ of the cover 20′. It will be understood by someone skilled in the art that the attachment means 50′ for the case 10 is necessary while the disc 12′, the recess 26′, the engaging means 34′ with gap 38′ and the other appropriate elements of the interior surface 24′ of the cover 20′ are preferred but not necessarily within the scope of the present invention.

As shown in FIG. 1, the two discs 12 and 12′ can be axially inserted into each recess 26 and 26′ of each interior surface 24 and 24′ of each cover 20 and 20′ along the respective dotted lines. Each disc 12 and 12′ is removably secured to the corresponding cover 20 and 20′ with the hole 16 and 16″ engaging the stems 36 and 36′ of the engaging means 34 and 34′. The case 1.0 is magnetically closed by bringing the two covers 20 and 20′ closer together as shown with arrow A1 in FIG. 1 when the magnet sections 52 and 54 are opposed to the magnet sections 54′ and 52′ respectively as shown with the arrows A2 in FIG. 3a. Understandingly, in this position the magnetic fields of the magnet sections 52 and 54′ and simultaneously of the magnet sections 54 and 52′ attract each other. In the event that the magnets are wrongly positioned, the user will effortlessly rotate one of the two covers 20, 20′ relative to the other one by approximately 180° in a plane generally parallel to the cover in order to position the magnets appropriately to close off the case 10. The final closed position of the case 10 is shown in FIG. 2b.

To open the case 10, the user either pulls the two covers 20, 20′ apart from one another or initiates a rotation of one of the two cover 20, 20″ relative to the other one as shown with the arrow A3 in FIG. 3b to position the magnet sections 52 and 52′ as well as the magnet sections 54 and 54′ respectively opposed to each other, configuration generally obtained after a rotation of more than 90°, more specifically of about 180°. One skilled in the art will understand that the magnetic fields of the opposite magnets will be contradictory and repel one another as shown by the arrows A4, thereby smoothly opening the case 10 since the repel will generally start after a rotation of only a few degrees such as approximately 20° to 30°.

Another characteristic of the present invention comes from the fact that the magnetic fields of the magnet sections 52 and 54 typically propagates through and extend beyond the cover 20 on the exterior surface 22 thereof. One can understand therefore that the same way a case 10 is closed, two opposite covers 20 and 200 of two separate cases 10 and 100 respectively can be stacked together for filing or storing purposes as shown in FIG. 2a. The cases 10 and 100 will remain connected together by the attracting forces of the magnets as explained previously in the case of the two covers 20 and 20′. Similarly also, the two cases 10 and 100 can be separated from each other by a simple rotational movement of the case 10 relative to the other case 100, movement that positions the magnetic fields of the opposite magnets contradictory to each other, thereby forcing the case 10 to be repelled from the case 100.

Alternative

In an alternate embodiment of the present invention, the attachment means of a case (not shown) may include one magnet in each cover. Each magnet has a preferably axial magnetic field and may be of the Neodymium Iron Boron (NdFeB) composition or the like. In order to enable closing the case, one skilled in the art will understand that each magnet of a cover must be positioned with its magnetic field opposing the magnetic field of the magnet in the opposing cover such that the two magnets attract each other. Thereby, to open the cover, a slight force has to be generated by the user to overcome the attracting force of the magnetic fields of the magnets of the opposite covers.

Another characteristic of this alternative embodiment is that to stack together two cases, an upside down flip of one of the case may be required to ensure the appropriate positioning of the magnetic field for an attraction of the opposite covers of the separate cases. Similarly to the situation when such a case needs to be opened, the separation of one case from the other requires a slight force to be generated by the user to overcome the attracting force of the magnetic fields of the magnets of the opposite cases.

Obviously, one skilled in the art would understand that the location of the magnets could differ from the one shown in the Figures without departing from the scope of the present invention. As an example, each cover could include four magnets, one at each corner thereof, that are all in a same magnetic orientation, or in pairs of opposite magnetic orientations.

Although not shown, the case of the present invention could similarly be made to receive more than one disc within each cover, the discs being either in a stacked or in a side-by-side relationship relative to one another, without departing from the scope of the present invention.

Although the present case 10 to store one or more discs and its alternative case (not shown) have been described with a certain degree of particularity, it is to be understood that the disclosure has been made by way of example only and that the present invention is not limited to the features of the embodiments described and illustrated herein, but includes all variations and modifications within the scope and spirit of the invention as hereinabove described.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A disc storage case for storing disc comprising:
a first and a second cover and said first and second covers being separatable from one another;
said first and second covers each having an exterior surface and an interior surface;
at least one of either said first cover or said second cover having a recess;
an engaging means situated in a generally central portion of said recess to engage a central hole of a disc;
an attachment means for said case situated on said interior surface of said first and second covers;
said attachment means comprising at least one magnet divided into two sections with different molecular orientations.

2. A disc storage case for storing disc having the following method of use:
a disc is axially inserted into a recess of an interior surface of a cover and engaging stems of an engaging means;
said case being opened by pulling said two covers apart from one another.

3. A disc storage case for storing disc having the following method of use:
a disc is axially inserted into a recess of an interior surface of a cover and engaging stems of an engaging means;
said case being opened by initiating a rotation of one of two said covers relative to the other one.

4. A disc storage case for storing disc as in claim 1 wherein:
two opposite covers of two separate cases respectively being stacked together by the attracting forces of said magnets.

5. A disc storage case for storing disc as in claim 1 wherein:
said cover having a generally rectangular and flat configuration, slightly larger than said disc.

6. A disc storage case for storing disc as in claim 1 wherein:
said case being manufactured with a rigid, light and inexpensive material.

7. A disc storage case for storing disc as in claim 1 wherein:
The depth of said recess being generally as of the thickness of said disc, while the outer of said recess being configured and sized to follow the outer perimeter of said disc.

8. A disc storage case for storing disc as in claim 1 wherein:
said generally circular engaging means having flexible projecting stems corresponding to the thickness of said disc and being preferably circularly positioned to engage edges defining a central hole of said disc.

9. A disc storage case for storing disc as in claim 1 wherein:
said stems further comprised of cogs or transversal projections at their upper section, said cogs pointing toward the outer edges of said recess in order to hold said disc more resiliently.

10. A disc storage case for storing disc as in claim 1 wherein:
an attachment means for said case situated on said interior surface preferably centrally located in-between said stems.

11. A disc storage case for storing disc as in claim 1 wherein:
each cover having at least one magnet at each corner of said cover wherein all said magnets being in a same magnetic orientation, or in pairs of opposite magnetic orientations.

12. A disc storage case for storing disc as in claim 1 wherein:
each magnet section having a preferably axial magnetic field.

13. A disc storage case for storing disc as in claim 1 wherein:
each magnet made of Neodymium Iron Boron (NdFeB) composition.

14. A disc storage case for storing disc as in claim 1 wherein:
said case receiving more than one disc within each cover, said discs being either in a stacked or in a side-by-side relationship relative to one another.
